(19) United States
(12) Patent Application Publication
(10) Pub. No.: US 2015/0266993 A1
(43) Pub. Date: Sep. 24, 2015

(54) FLAME RETARDED SLABSTOCK POLYURETHANE FOAM COMPOSITION FOR FLAME LAMINATION

(71) Applicant: HYUNDAI MOTOR COMPANY, Seoul (KR)

(72) Inventors: Kwon Yong CHOI, Seoul (KR); Soon Joon JUNG, Seoul (KR); Byung Guk LIM, Seoul (KR); Jeong Seok OH, Yongin-si (KR); Ki Yeon JEONG, Hwaseong-si (KR); Il Gon LEE, Ansan-si (KR); Heon Hee PARK, Yeosu-si (KR)

(21) Appl. No.: 14/660,621

(22) Filed: Mar. 17, 2015

(30) Foreign Application Priority Data
Mar. 21, 2014 (KR) 10-2014-00033534

(51) Int. Cl. C08G 18/08; C08G 18/76; C08G 18/40; C08G 18/48

(52) U.S. Cl. CPC C08G 18/14; C08G 18/48; C08G 18/7607; C08G 18/4018; C08G 18/7671

(57) ABSTRACT

The present disclosure provides a flame retarded slabstock polyurethane foam composition for flame lamination, which does not need to add a separate flame retardant additive because the polyurethane itself has flame retardancy. The flame retarded slabstock polyurethane foam composition for flame lamination according to the present disclosure, wherein the foam itself has flame retardancy by comprising methylene diphenyl diisocyanate (MDI), polymethylene diphenyl diisocyanate (PMDI), or a mixture thereof as an isocyanate compound, thereby obtaining an epochal effect that it does not need to add a separate flame retardant and an effect of solving a problem that physical properties of the conventional flame retarded slabstock polyurethane foam composition are reduced by adding a flame retardant.

### CROSS-REFERENCE TO RELATED APPLICATION

This application claims under 35 U.S.C. §119(a) the benefit of Korean Patent Application No. 10-2014-0033534 filed on Mar. 21, 2014, the entire contents of which are incorporated herein by reference.

### BACKGROUND

(a) Technical Field

The present disclosure relates to a flame retarded slabstock polyurethane foam composition for flame lamination, which does not require a separate flame retardant additive.

(b) Background Art

In general, ‘lamination’ refers to a product manufactured by adhering a raw material and a subsidiary material using adhesive resin or heat. Examples of raw materials include natural leather, synthetic leather, and fabric. The subsidiary material may be soft polyurethane foam. In a specific lamination technique known as “flame adhesion,” soft polyurethane foam used as a subsidiary material is often called ‘flame lamination foam’.

Lamination products are often used for leather or fabric covering of vehicle seats, sofas, office chairs and the like. They are used to upgrade products by making them more comfortable and therefore more desirable.

A method for manufacturing flame lamination foam includes a number of steps. The main material and various additives are weighed through a metering pump. They are transferred to a mixing head of a foam generator, stirred, and discharged to a conveyor belt moving horizontally at constant speed. They are then reacted, so as to be continuously or discontinuously made in the form of a block foam with constant size, cured for a certain time, and processed to the size or shape suited for customer's needs.

Soft polyurethane foam used as flame lamination foam is a slabstock foam. It is manufactured by using polyol and toluene diisocyanate (TDI) as a main material and adding various additives such as flame retardant, catalyst and blowing agent. [Korean Patent Registration No. 10-1321576 and Korean Patent Publication No. 10-2010-0052928]

Toluene diisocyanate (TDI) used as a main material is a mixture of isomers, 2,4-toluene diisocyanate 80% and 2,6-toluene diisocyanate 20%. It has the advantages of easy control of foam density and excellent processability due to its excellent foaming ratio. However, when foaming, the reaction heat inside of the foam is increased to about 170 to 180° C., and this reaction heat accumulates inside of the foam until the reaction is completed. Because this may cause scorching, wherein the inside of the foam is discolored or fired by carbonization, the product value is likely to be reduced. In more serious cases, the increase of internal reaction heat may cause a big fire. Therefore, it is very important to prevent accumulation of the internal reaction heat when manufacturing polyurethane foam.

An important characteristic of slabstock polyurethane foam used in flame lamination is flame retardancy. In the case of polyurethane foam applied to a vehicle interior, flame retardancy of polyurethane foam is regulated by standardization at local and product manufacturer (e.g.: FMVSS-302, BS-5852, California No.117 and the like) with the object of reducing gas production caused by burning time delay and preventing fire.

Methods for improving flame retardancy of polyurethane foam include 1) using flame retardant material, wherein flame retardant atoms such as phosphorus, nitrogen or halogen are chemically bonded to polyol or isocyanate, and more commonly, 2) adding a separate flame retardant additive

Examples of flame retardant additives include a halogen-based flame retardant, a phosphorus-based flame retardant, a nitrogen-based flame retardant, and an inorganic flame retardant. The halogen-containing phosphorus-based flame retardant, when added to polyurethane foam, has a flame retardant effect due to its composition of halogen and phosphorus atoms, tris(2-chloropropyl)phosphate (TCPP), tris(2-chloroethyl)phosphate (TCEP), phosphinyl alkyl phosphate ester (CR530) and the like. It is known that the halogen atom is converted to a gas-type molecule or atom when combusted and stabilizes active radicals, thereby having a flame retardant effect. However, because the halogen-containing flame retardant additive has low molecular weight, it may be easily scattered at high temperature. Further, when polyurethane foam containing a halogen-based flame retardant is used as the covering of a vehicle seat, hydrogen halide, amine salt generated by phosphoric acid ester, and amine catalyst contained in raw material of foam or decomposition of phosphoric acid ester are scattered in the vehicle. The scattering of these compounds may cause fogging of the windows of a vehicle under high temperature conditions.

Further, there are problems of corrosion of metals caused by gas generated in the case of combustion, and reduction of flame retardancy as time goes on. The 1983 announcement in Germany that dioxin, a carcinogen, is generated when combusting a halogen-containing flame retardant heralded the discovery of a series of environmental problems. Thereafter, use of the halogen-based flame retardant, which releases toxic HCl and HBr gas, started to be regulated in European countries. Recently, the use regulation bill of two flame retardants such as tris(2-chloroethyl)phosphate (TCPP) and tris(1,3-dichloro-2-propyl)phosphate (TDCPP) was approved in the U.S.

Thus, as the addition of a separate flame retardant additive is heavily regulated, there is an urgent need for developing a flame retarded slabstock polyurethane foam composition that is integrally flame retardant.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

As a solution to the problems associated with prior art described hereinabove, an objective of the present disclosure is to provide a slabstock polyurethane foam composition for flame lamination, having integral flame retardancy, thereby eliminating the need for a separate flame retardant additive.

The present disclosure provides a polyurethane foam composition comprising polyol and isocyanate compound as main ingredients, as well as other additives for forming general polyurethane foam with the possibility of exclusion of a separate flame. One embodiment of a flame retarded slabstock polyurethane foam composition for flame lamination comprises:

(1) 100 parts per weight of polyol comprising polyether polyol or polyester polyol having weight average molecular weight (Mw) of 3,000 to 8,000 g/mol and OH value of 20 to 60 mg KOH/g, or a mixture thereof; (2) 30 to 70 parts per weight of isocyanate compound comprising at least one selected out of methylene diphenyl diisocyanate, polymethylene diphenyl diisocyanate and derivatives thereof; and (3) 1 to 20 parts per weight of other additives.

In an embodiment, the isocyanate compound may further comprise toluene diisocyanate.

In another embodiment, the isocyanate compound may be a mixture of methylene diphenyl diisocyanate 60 to 80 wt % and polymethylene diphenyl diisocyanate 20 to 40 wt %.

In still another embodiment, the isocyanate compound may be a mixture of ethylene diphenyl diisocyanate, polymethylene diphenyl diisocyanate or a mixture thereof 20 to 80 wt % and toluene diisocyanate 20 to 80 wt %.

In yet another embodiment, the methylene diphenyl diisocyanate may have NCO content of 20 to 50 wt %.

In still yet another embodiment, the polymethylene diphenyl diisocyanate may have weight average molecular weight (Mw) of 370 to 390 g/mol and NCO content of 20 to 50 wt %.

In another aspect, the present disclosure provides a flame retarded slabstock polyurethane foam for flame lamination, which is manufactured via foam-molding.

Other aspects and embodiments, as well as the above and other features of the inventive concept are discussed hereinbelow.

### BRIEF DESCRIPTION OF THE DRAWINGS

The above and other features of the present disclosure will now be described in detail with reference to certain exemplary embodiments thereof illustrated by the accompanying drawings which are given hereinbelow by way of illustration only, and thus are not limitative of the present disclosure, and wherein:

FIG. 1 is shows a comparison of the combustibility of a slabstock polyurethane foam manufactured by using toluene diisocyanate (TDI) as an isocyanate compound (Comparative Example 1) and with that of a slabstock polyurethane foam manufactured by using a mixture of methylene diphenyl diisocyanate (MDI) and polymethylene diphenyl diisocyanate (PMDI) (Example 3, 80:20 wt %); and

FIG. 2 shows a comparison of the combustibility of slabstock polyurethane foams manufactured by using TDI (Comparative Example 1), a mixture of TDI and PMDI (Example 1, 80:20 wt %), a mixture of TDI and PMDI (Example 2, 50:50 wt %) and a mixture of MDI and PMDI (Example 3, 80:20 wt %), respectively, as an isocyanate compound.

It should be understood that the appended drawings are not necessarily to scale and present a simplified representation of various preferred features illustrative of the basic principles of the disclosure. The specific design features disclosed herein, including, for example, specific dimensions, orientations, locations, and shapes, will be determined in part by the particular intended application and use environment.

### DETAILED DESCRIPTION

Hereinafter reference will now be made in detail to various embodiments of the present inventive concept, examples of which are illustrated in the accompanying drawings and described below. While the inventive concept will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the invention as defined by the appended claims.

The present disclosure relates to a flame retarded slabstock polyurethane foam composition for flame lamination.

The slabstock polyurethane foam composition for flame lamination of the present disclosure consists primarily of polyol and an isocyanate compound as well as other additives generally used for forming polyurethane foam. The polyol and the isocyanate compound used engender integral flame retardancy in the foam. Thus, the foam has enough flame retardant effect even though it does not use a separate flame retardant additive. Namely, the present inventive concept comprises a flame retarded slabstock polyurethane foam composition for flame lamination having novel composition that does not contain flame retardant as other additive.

Each ingredient included in the flame retarded slabstock polyurethane foam composition for flame lamination according to the present disclosure will be described in detail.

(1) Polyol

In the present disclosure, polyether polyol, polyester polyol, or a mixture thereof is used as polyol.

The polyether polyol is obtained by addition polymerization of ethylene oxide (EO) and propylene oxide (PO), and may have a weight average molecular weight (Mw) of 3,000 to 8,000 g/mol and OH value of 20 to 60 mg KOH/g. At this time, it may be advantageous to control the content of the ethylene oxide (EO) and the propylene oxide (PO) within the range of 10 to 20:80 to 90 wt % of the combined weight of the EO and the PO in order to minimize collapse and shrinkage during the foaming process. Further, in the addition polymerization reaction, at least one selected from the group consisting of ethylene glycol, glycerin, triethanol amine, pentaerythritol, toluene diamine, ethylene diamine, 4,4′-diaminodiphenylmethane, sorbitol and sucrose may be used as a polymerization initiator.

The polyester polyol is obtained by dehydrating condensation of a dicarboxylic acid compound and a polyalcohol compound, and may have a weight average molecular weight (Mw) of 3,000 to 8,000 g/mol and OH value of 20 to 60 mg KOH/g. The dicarboxylic acid compound may be at least one selected from the group consisting of terephthalic acid, ethylene adipic acid, butylene adipic acid, 1,6′-hexane adipic acid, diethylene adipic acid and phthalic acid. The polyalcohol compound may be at least one selected from the group consisting of 1,4-butanediol and ethylene glycol.

The polyether polyol or the polyester polyol used in the present disclosure is not always limited thereto, and any polyether polyol and polyester polyol, which can be used in the art may be variously used.

It is generally advantageous that the molecular weight and OH value of the polyether polyol or the polyester polyol be limited to a certain range. For example, when weight average molecular weight (Mw) of the polyether polyol or the polyester polyol is less than 3,000 g/mol, the foam may collapse or crack during manufacture. When the weight average molecular weight (Mw) is over 8,000 g/mol, the foam may not maintain its original shape due to the possibility of shrinkage. Similar effect may occur when OH value (hydroxy value) is less than 20 mg KOH/g or more than, 80 mg KOH/g.

(2) Isocyanate Compound

In the present disclosure, at least one selected from the group consisting of methylene diphenyl diisocyanate (MDI), polymethylene diphenyl diisocyanate (PMDI) and derivatives thereof may be used as an isocyanate compound. At this time, the NCO content of the MDI may be 20 to 50 wt %. And, weight average molecular weight (Mw) of the PMDI may be 370 to 390 g/mol and NCO content thereof may be 20 to 50 wt %. A mixture of MDI and PMDI may be used as the isocyanate compound. The mixing ratio MDI:PMDI may be 60 to 80 wt %:20 to 40 wt %, or 70 to 80:20 to 30 wt %. The use of a mixture of MDI and PMDI causes integral flame retardancy in the polyurethane foam.

Further, the present disclosure may further comprise toluene diisocyanate (TDI) as an isocyanate compound. However, toluene diisocyanate (TDI) has higher reaction heat, which may cause scorching when manufacturing polyurethane foam, but when MDI, PMDI, or a mixture thereof is used as an isocyanate compound, the said problem may be solved, with the additional effect of causing integral flame retardancy

In order to manufacture the flame retarded polyurethane foam according to the present disclosure, as an isocyanate compound, a mixture of 20 to 80 wt % of MDI, PMDI, or a mixture thereof and 20 to 80 wt % of toluene diisocyanate (TDI) may be used. More preferably, as an isocyanate compound, a mixture of 40 to 60 wt % of MDI, PMDI or a mixture thereof and 40 to 60 wt % of toluene diisocyanate (TDI) may be used.

Based on reference [Can. J. Chem. 1962, 40, p. 23˜30 “Thermochemical Studies of Some Alcohol-Isocyanate Reactions”; “Flexible Polyurethane Foam”, 1991. Chap. 2.4], reaction heat capacity of each isocyanate compound in the reaction for manufacturing polyurethane foam was calculated. As a result, compared to toluene diisocyanate (TDI), reaction heat capacity of MDI was about 31% lower, and reaction heat capacity of PMDI was about 35% lower. When compared to toluene diisocyanate (TDI), when forming polyurethane foam, MDI and PMDI had relatively lower heat of formation, thereby having effects of preventing scorching, as discussed hereinabove, and improving deterioration of physical properties such as hardness and permanent compression set.

The effect of providing flame retardancy to polyurethane foam through reaction with a certain polyol by using MDI, PMDI, or a mixture thereof as an isocyanate compound is described above. In order to maximize this flame retardancy, NCO content of MDI may be limited to 20 to 50 wt %, and weight average Mw and NCO contents of PMDI may be limited to 370 to 390 g/mol and 20 to 50 wt %, respectively.

Further, in the present disclosure, NCO content of MDI and PMDI used as an isocyanate compound may be limited so as to obtain desirable physical properties by optimizing the foaming ratio when manufacturing polyurethane foam. In certain instances, when NCO content of MDI and PMDI used as an isocyanate compound is less than 20 wt %, foaming ratio may become low, which may cause the physical properties to deteriorate, and when it is over 50 wt %, shrinkage, cracking, tearing and/or collapse may occur. However, even beyond the said range, the object of the present disclosure will be achieved.

(3) Other Additives

In addition to polyol and isocyanate compound, the polyurethane foam of the present disclosure may include other additives. In the composition of the present invention isclosure, the other additives may be at least one selected from the group consisting of blowing agent, catalyst, cross-linker, surfactant, and cell opener. These other additives may be properly contained in an amount of 0.1 to 50 parts per weight, and preferably 1 to 20 parts per weight, based on 100 parts per weight of polyol, and in the present disclosure, selection of the other additives may not be limited. The present inventive concept does not require flame retardant as an additive. However, a small amount of flame retardant additives may be added.

Namely, in the related art, flame retardant additive is essential to obtain flame retarded slabstock polyurethane foam, but in the present disclosure, the polyurethane foam itself has flame retardancy through selecting polyol and isocyanate compound as the main ingredients. Therefore, flame retarded slabstock polyurethane foam can be obtained without adding a separate flame retardant additive. The slabstock polyurethane foam composition of the present disclosure has an advantage that it can show enough flame retardancy without containing the flame retardant additive. However, adding a small amount of flame retardant additive to the polyurethane foam composition as occasion demands would still be included in the scope of the present inventive concept. Examples of other additives to the slabstock polyurethane foam composition of the present disclosure are described in detail hereinbelow.

One example of a possible additive to the polyurethane foam of this disclosure is a blowing agent. The blowing agent may be selected to optimize various physical properties of the foam such as density. The blowing agent may be water. Additionally or alternatively, at least one selected from the group consisting of methylene chloride, n-butane, isobutane, n-pentane, isopentane, dimethyl ether, acetone and carbon dioxide (CO₂) may be used. Accordingly, in the present disclosure, the amount of the blowing agent is not particularly limited. However, amount of the blowing agent may be 0.1 to 40 parts per weight, based on 100 parts per weight of polyol.

Another example of a component that may be added to polyurethane foam is a catalyst. The catalyst plays a role of stimulating reaction between polyol and isocyanate compound. This catalyst may be at least one selected from among tertiary amine catalyst such as triethylene diamine, triethyl amine, N-methyl morpholine and N-ethyl morpholine, and organo-tin catalyst such as stannous octoate and dibutyltin dilaurate (DBTDL). The catalyst may be used in an amount of 0.1 to 3 parts per weight, and preferably 0.3 to 2 parts per weight, based on 100 parts per weight of polyol. Another possible additive is a cross-linker. The cross-linker may be glycol-type or amine-type. For example, it may be selected from among ethylene glycol, diethylene glycol, triethylene glycol, dipropylene glycol, 1,4-butanediol, 1,6-hexanediol, pentaerythritol, diethanol amine, triethanol amine, ethylene diamine, triethylene tetramine, 4,4-diphenylmethanediamine, 2,6-dichloro-4,4-diphenylmethanediamine, 2,4-toluene diamine and 2,6-toluene diamine, but not always limited thereto. The cross-linker may be used in an amount of 0.001 to 10 parts per weight, and preferably 0.01 to 5 parts per weight, based on 100 parts per weight of polyol.

Yet another possible additive is a surfactant. The surfactant plays roles of preventing confluence or destruction of the formed cells when the cells are formed inside polyurethane foam, and controlling the formation of cells having uniform shape and size. This surfactant may be any surfactant generally used in the art, and not particularly limited. And it may be organo-silicon-type surfactant in general. The organo-silicon-type surfactant may be at least one selected out of silicon oil and derivatives thereof. The surfactant may be used in an amount of 0.3 to 5 parts per weight, and preferably 0.5 to 2 parts per weight, based on 100 parts per weight of polyol. At this time, if the amount of the surfactant used is too small, formation of the foam may be not uniform, and if it is too much, the foam may be shrunk.

Another example of a possible additive is a cell opener. The cell opener may be polyether polyol. Specifically, the cell opener is obtained by addition polymerization of ethylene oxide (EO) and propylene oxide (PO), and polyether polyol, wherein weight ratio of EO:PO is 50 to 80:20 to 50 wt %, weight average molecular weight (Mw) is 3,000 to 8,000 g/mol, and OH value is 20 to 60 mg KOH/g, may be used. The cell opener may be used in an amount of 1 to 20 parts per weight, and preferably 2 to 8 parts per weight, based on 100 parts per weight of polyol. At this time, if the amount of the cell opener is too small, the foam may be shrunk, thereby its original shape is not maintained, and if it is too much, the foam may be collapsed or cracked.

### EXAMPLES

The following examples illustrate the inventive concept and are not intended to limit the same.

### Examples 1 to 6 and Comparative Examples 1 to 8

Polyol resin premix was prepared by mixing polyol, cross-linker, catalyst, organo-silicon surfactant, cell opener and water according to ingredients and content ratio shown in the following Tables 1 and 2, and then an isocyanate compound was added thereto. The sample was collected using index 105, mixed and stirred, and then injected into a 400×400×400 mm box mold. Reactivity and appearance were confirmed, and then combustibility, density, hardness, tensile strength, elongation and tearing strength were measured the next day.

[Method for Evaluating Physical Properties]

(1) Forming density: measured by KS-M-6672

(2) Elongation: measured by KS-M-ISO-7214

(3) Tensile strength: measured by KS-M-ISO-7214

(4) Tearing strength: measured by KS-M-ISO-7214

(5) Combustibility: measured by FMVSS-302, MS-300-08

Foam Length: 350 mm, Width: 100 mm, Thickness: 13 mm

Combustibility Evaluation: ⊚, O (SE: self-extinguishing), Δ, X (combustibility)

[Used Ingredient]

1) Polyol

a) H-6000: Polyether polyol (Kumho Petrochemical); polyether polyol manufactured by using glycerin as an initiator, and addition polymerization of propylene oxide and ethylene oxide at the content ratio of 15:85 wt %, weight average molecular weight (Mw) of 5,500 to 6,500 g/mol, OH value of 28 mg KOH/g

b) U-1340: Polyester polyol (Union Chemicals, Inc); weight average molecular weight (Mw) of 3,500 to 4,500 g/mol, OH value of 28 mg KOH/g

2) Isocyanate

a) TDI: Toluene diisocyanate (KPX Chemical Co. Ltd), NCO content of 48.3 wt %

b) TM-20: A mixture of toluene diisocyanate 80 wt % and polymethylene diphenyl diisocyanate (Mw 380) 20 wt % (Kumho Mitsui Chemicals Inc), NCO content of 45.0 wt %

c) TM-50: A mixture of toluene diisocyanate 50 wt % and polymethylene diphenyl diisocyanate (Mw 380) 50 wt % (Kumho Mitsui Chemicals Inc), NCO content of 40.0 wt %

d) CG-29N: A mixture of methylene diphenyl diisocyanate 80 wt % and polymethylene diphenyl diisocyanate (Mw 380) 20 wt % (Kumho Mitsui Chemicals Inc), NCO content of 27.5%

e) G-130B: A mixture of methylene diphenyl diisocyanate 20 wt % and polymethylene diphenyl diisocyanate (Mw 380) 80 wt % (Kumho Mitsui Chemicals Inc), NCO content of 31.5%

3) Other Additive

a) Cross-linker: Diethanol amine

b) Gelling catalyst: 33LV (Aminecatalyst, OSI)

c) Blowing catalyst: A-1 (Aminecatalyst, OSI)

d) Surfactant: L-5309 (Momentive)

e) Cell opener: Y-8331 (SKC); Polyether polyol manufactured by using glycerin as an initiator, and addition polymerization of ethylene oxide and propylene oxide at content ratio of 70:30 wt %, weight average molecular weight (Mw) of 5,000 g/mol, OH value of 30 mg KOH/g

f) Flame retardant: TCPP (tris(2-chloropropyl)phosphate)

TABLE 1

| | | | Examples | | | | Comparative Examples | | | |
|---|---|---|---|---|---|---|---|---|---|---|
| Classification | | | 1 | 2 | 3 | 4 | 1 | 2 | 3 | 4 |
| Composition | Polyol | H-6000 | 100 | 100 | 100 | 100 | 100 | 100 | 100 | 100 |
| Ingredient | Isocyanate | TDI | 0 | 0 | 0 | 0 | 50 | 50 | 50 | 50 |
| (part per | | TM-20 | 50 | 0 | 0 | 0 | 0 | 0 | 0 | 0 |
| weight) | | TM-50 | 0 | 50 | 0 | 0 | 0 | 0 | 0 | 0 |
| | | CG-29N | 0 | 0 | 50 | 0 | 0 | 0 | 0 | 0 |
| | | JG-130B | 0 | 0 | 0 | 50 | 0 | 0 | 0 | 0 |
| | Cross-linker | Diethanol | 0.63 | 0.63 | 0.63 | 0.63 | 0.63 | 0.63 | 0.63 | 0.63 |
| | | Amine | | | | | | | | |
| | Gelling | 33LV | 0.27 | 0.27 | 0.27 | 0.27 | 0.27 | 0.27 | 0.27 | 0.27 |
| | Catalyst | | | | | | | | | |
| | Blowing | A-1 | 0.05 | 0.05 | 0.05 | 0.05 | 0.05 | 0.05 | 0.05 | 0.05 |
| | Catalyst | | | | | | | | | |
| | Surfactant | L-5309 | 0.90 | 0.90 | 0.90 | 0.90 | 0.90 | 0.90 | 0.90 | 0.90 |
| | Cell Opener | Y-8331 | 4.52 | 4.52 | 4.52 | 4.52 | 4.52 | 4.52 | 4.52 | 4.52 |
| | Flame | TCPP | 0 | 0 | 0 | 0 | 0 | 4.32 | 8.29 | 11.94 |
| | Retardant | | | | | | | | | |

| | | | | | | | | | |
|---|---|---|---|---|---|---|---|---|---|
| | Water | 3.17 | 3.17 | 3.17 | 3.17 | 3.17 | 3.17 | 3.17 | 3.17 |
| Physical | Forming Density (kg/m³) | 40 | 40 | 40 | 40 | 40 | 40 | 40 | 40 |
| Properties | Elongation (%) | 135 | 121 | 138 | 120 | 130 | 121 | 115 | 108 |
| | Tensile Strength (kgf/cm²) | 1.23 | 1.21 | 1.40 | 1.21 | 1.30 | 1.24 | 1.08 | 1.08 |
| | Tearing Strength | 0.76 | 0.87 | 0.97 | 0.78 | 0.84 | 0.80 | 0.64 | 0.62 |
| | (kgf/cm) | | | | | | | | |
| | Combustibility | ◯ | ◯ | ⊚ | ⊚ | X | Δ | ◯ | ⊚ |
| | (mm/min) | (S.E) | (S.E) | (S.E) | (S.E) | (64.4) | (13.5) | (S.E) | (S.E) |

As shown in Table 1, Examples 1 to 4 are slabstock polyurethane foam compositions comprising MDI, PMDI or a mixture thereof as an isocyanate compound, and it was confirmed that their flame retardancies are outstandingly improved compared to Comparative Example 1 comprising toluene diisocyanate (TDI). Even in Examples 1 to 4, Example 3 and Example 4 are slabstock polyurethane foam compositions comprising a mixture of MDI and PMDI, and it was confirmed that their flame retardancies are better than Example 1 and Example 2 comprising only PMDI. Further, Example 3 and Example 4 are slabstock polyurethane foam compositions manufactured by varying mixing ratio of MDI and PMDI, and it was confirmed that Example 3 keeping the MDI:PMDI of 80:20 wt % has effects of improving physical properties such as elongation, tensile strength and tearing strength as well as flame retardancy.

On the contrary, Comparative Examples 1 to 4 are slabstock polyurethane foam compositions comprising toluene diisocyanate (TDI) as an isocyanate compound, and it was confirmed that these showed flame retardancy using ratios only when the flame retardant content was increased. However, it was confirmed that physical properties were significantly deteriorated as the flame retardant content was increased.

TABLE 2

| | | | Examples | | | | Comparative Examples | | | |
|---|---|---|---|---|---|---|---|---|---|---|
| Classification | | | 5 | 6 | 7 | 8 | 5 | 6 | 7 | 8 |
| Composition | Polyol | H-6000 | 50 | 50 | 50 | 50 | 80 | 50 | 50 | 50 |
| Ingredient | | U-1340 | 50 | 50 | 50 | 50 | 20 | 50 | 50 | 50 |
| (part per | Isocyanate | TDI | 0 | 0 | 0 | 0 | 50 | 50 | 50 | 50 |
| weight) | | TM-20 | 50 | 0 | 0 | 0 | 0 | 0 | 0 | 0 |
| | | TM-50 | 0 | 50 | 0 | 0 | 0 | 0 | 0 | 0 |
| | | CG-29N | 0 | 0 | 50 | 0 | 0 | 0 | 0 | 0 |
| | | JG-130B | 0 | 0 | 0 | 50 | 0 | 0 | 0 | 0 |
| | Cross-linker | Diethanol | 0.63 | 0.63 | 0.63 | 0.63 | 0.63 | 0.63 | 0.63 | 0.63 |
| | | Amine | | | | | | | | |
| | Gelling | 33LV | 0.27 | 0.27 | 0.27 | 0.27 | 0.27 | 0.27 | 0.27 | 0.27 |
| | Catalyst | | | | | | | | | |
| | Blowing | A-1 | 0.05 | 0.05 | 0.05 | 0.05 | 0.05 | 0.05 | 0.05 | 0.05 |
| | Catalyst | | | | | | | | | |
| | Surfactant | L-5309 | 0.90 | 0.90 | 0.90 | 0.90 | 0.90 | 0.90 | 0.90 | 0.90 |
| | Cell Opener | Y-8331 | 4.52 | 4.52 | 4.52 | 4.52 | 4.52 | 4.52 | 4.52 | 4.52 |
| | Flame | TCPP | 0 | 0 | 0 | 0 | 0 | 0 | 8.29 | 11.94 |
| | Retardant | | | | | | | | | |

| | | | | | | | | | |
|---|---|---|---|---|---|---|---|---|---|
| | Water | 3.17 | 3.17 | 3.17 | 3.17 | 3.17 | 3.17 | 3.17 | 3.17 |
| Physical | Forming Density (kg/m³) | 40 | 40 | 40 | 40 | 40 | 40 | 40 | 40 |
| Properties | Elongation (%) | 149 | 141 | 148 | 135 | 130 | 129 | 119 | 112 |
| | Tensile Strength | 1.22 | 1.23 | 1.33 | 1.25 | 1.10 | 1.10 | 1.05 | 1.02 |
| | (kgf/cm²) | | | | | | | | |
| | Tearing Strength | 0.81 | 0.82 | 0.98 | 0.80 | 0.78 | 0.70 | 0.62 | 0.62 |
| | (kgf/cm) | | | | | | | | |
| | Combustibility | ◯ | ◯ | ⊚ | ⊚ | X | X | ◯ | ⊚ |
| | (mm/min) | (S.E) | (S.E) | (S.E) | (S.E) | (58.5) | (54.1) | (S.E) | (S.E) |

The above Table 2 illustrates slabstock polyurethane foam compositions using a mixture of polyether polyol and polyester polyol as a polyol.

As shown in Table 2, Examples 5 to 8 are slabstock polyurethane foam compositions comprising MDI, PMDI, or a mixture thereof as an isocyanate compound, and it was confirmed that these have outstandingly improved flame retardancy compared to Comparative Example 6 comprising toluene diisocyanate (TDI). Even in Examples 5 to 8, Example 7 and Example 8 are slabstock polyurethane foam compositions using a mixture of MDI and PMDI, and it was confirmed that these have excellent flame retardancy compared to Example 5 and Example 6 using only PMDI. Further, Example 7 and Example 8 are slabstock polyurethane foam compositions manufactured by varying mixing ratio of MDI and PMDI, and it was confirmed that Example 7 keeping the 80:20 wt % ratio of MDI:PMDI has effects of improving physical properties such as elongation, tensile strength, and tearing strength as well as flame retardancy.

On the contrary, Comparative Examples 5 to 8 are slabstock polyurethane foam compositions comprising toluene diisocyanate (TDI) as an isocyanate compound, and it was confirmed that those showed flame retardancy using ratios only when the flame retardant content was increased. However, it was confirmed that physical properties were significantly deteriorated as the flame retardant content was increased.

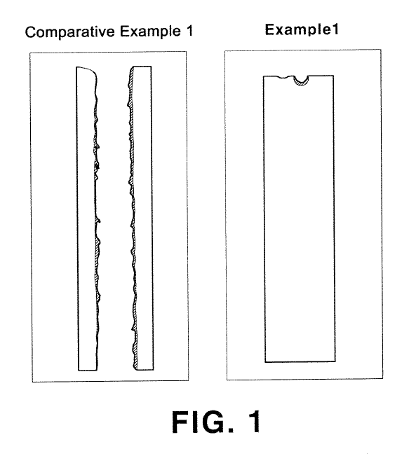

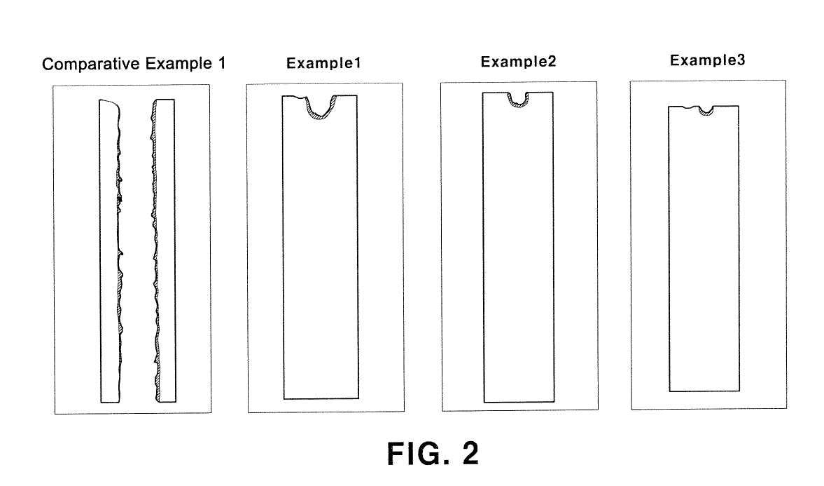

Further, FIG. 1 is images showing the result of comparing combustibility of slabstock polyurethane foams manufactured in Example 3 and Comparative Example 1, and FIG. 2 is images showing the result of comparing combustibility of slabstock polyurethane foams manufactured in Examples 1 to 3 and Comparative Example 1.

As depicted in FIGS. 1-2, it was confirmed that the slabstock polyurethane foam of Examples 1 to 3 according to the present disclosure has outstandingly excellent flame retardancy compared to Comparative Example 1.

As described above, the flame retarded slabstock polyurethane foam composition for flame lamination according to the present disclosure, wherein the foam itself has flame retardancy by comprising MDI, PMDI, or a mixture thereof as an isocyanate compound, thereby obtaining an epochal effect that it does not need to add a separate flame retardant and an additional effect of solving a problem that physical properties of the conventional flame retarded slabstock polyurethane foam composition are reduced by adding a flame retardant.

Accordingly, the flame retarded slabstock polyurethane foam composition of the present disclosure is useful as a material for bedding, vehicle interior particularly, vehicle seats, among other products.

As the slabstock polyurethane foam composition of the present disclosure is integrally fire retardant, it has an advantage that it does not need to add a separate flame retardant additive. Therefore, it does not generate fumed materials or carcinogens, unlike using flame retardant additives.

Further, as the slabstock polyurethane foam composition of the present disclosure, does not require the addition of toluene diisocyanate (TDI) as an isocyanate compound, and instead, may use a certain isocyanate compound having low reaction heat such as methylene diphenyl diisocyanate and polymethylene diphenyl diisocyanate, scorching may be prevented by lowering heat of formation when foaming, and improving deterioration of physical properties such as hardness and permanent compression set.

The inventive concept has been described in detail with reference to numerous embodiments thereof. However, it will be appreciated by those skilled in the art that changes may be made in these embodiments without departing from the principles and spirit of the invention, the scope of which is defined in the appended claims and their equivalents.

1. In a polyurethane foam composition comprising polyol, isocyanate compound, and at least one other non-flame-retardant additive.

2. The polyurethane foam composition of claim 1, comprising:
(1) 100 parts per weight of polyol comprising polyether polyol or polyester polyol having weight average molecular weight (Mw) of 3,000 to 8,000 g/mol and OH value of 20 to 60 mg KOH/g, or a mixture thereof;
(2) 30 to 70 parts per weight of isocyanate compound comprising methylene diphenyl diisocyanate, polymethylene diphenyl diisocyanate, or a mixture thereof; and
(3) 1 to 20 parts per weight of other additives.

3. The polyurethane foam composition of claim 1, wherein the isocyanate compound further comprises toluene diisocyanate.

4. The polyurethane foam composition of claim 1, wherein the isocyanate compound is a mixture of methylene diphenyl diisocyanate 60 to 80 wt % and polymethylene diphenyl diisocyanate 20 to 40 wt %.

5. The polyurethane foam composition of claim 1, wherein the isocyanate compound is a mixture of methylene diphenyl diisocyanate 70 to 80 wt % and polymethylene diphenyl diisocyanate 20 to 30 wt %.

6. The polyurethane foam composition n of claim 3, wherein the isocyanate compound is a mixture of methylene diphenyl diisocyanate, polymethylene diphenyl diisocyanate, or a mixture thereof, 20 to 80 wt % and toluene diisocyanate, 20 to 80 wt %.

7. The polyurethane foam composition for flame lamination of claim 1, wherein the methylene diphenyl diisocyanate has NCO content of 20 to 50 wt %.

8. The polyurethane foam composition for flame lamination of claim 1, wherein the polymethylene diphenyl diisocyanate has weight average molecular weight of 370 to 390 g/mol and NCO content of 20 to 50 wt %.

9. A flame retarded slabstock polyurethane foam for flame lamination, which is manufactured by foam-molding the composition of claim 1.

10. The polyurethane foam of claim 1, wherein the polyurethane foam is integrally flame retardant.

11. The polyurethane foam of claim 1, further comprising a small amount of flame retardant additive.

12. A method of manufacturing a polyurethane foam comprising polyol, isocyanate compound, and at least one other non-flame-retardant additive, wherein the polyurethane foam is integrally flame retardant.

13. The polyurethane foam composition for flame lamination of claim 3, wherein the methylene diphenyl diisocyanate has NCO content of 20 to 50 wt %.

14. The polyurethane foam composition for flame lamination of claim 4, wherein the methylene diphenyl diisocyanate has NCO content of 20 to 50 wt %.

15. The polyurethane foam composition for flame lamination of claim 3, wherein the polymethylene diphenyl diisocyanate has weight average molecular weight of 370 to 390 g/mol and NCO content of 20 to 50 wt %.

16. The polyurethane foam composition for flame lamination of claim 4, wherein the polymethylene diphenyl diisocyanate has weight average molecular weight of 370 to 390 g/mol and NCO content of 20 to 50 wt %.
